(19) United States
(12) Patent Application Publication
(10) Pub. No.: US 2025/0370482 A1
(43) Pub. Date: Dec. 4, 2025

(54) MOBILE BODY PASSAGE MANAGEMENT SYSTEM, AND MOBILE BODY PASSAGE MANAGEMENT METHOD

(71) Applicant: Octa Robotics, Inc., Tokyo (JP)

(72) Inventor: Kota NABESHIMA, Tokyo (JP)

(21) Appl. No.: 18/875,298

(22) PCT Filed: Apr. 27, 2023
(86) PCT No.: PCT/JP2023/016774

§ 371 Date: Dec. 16, 2024

(30) Foreign Application Priority Data
Jul. 28, 2022 (JP) 2022-120142

(51) Int. Cl. G05D 1/698; G05D 101/00; G05D 107/70

(52) U.S. Cl. CPC G05D 1/6987; G05D 2101/22; G05D 2107/70

(57) ABSTRACT

A mobile body passage management system that manages passage of a mobile body that moves autonomously includes a storage unit that stores a resource necessary for passage of the mobile body as resource data, a resource management unit that manages an allocation situation of the resource to the mobile body, and a use request processing unit that receives a request from the mobile body, performs new allocation of the resource, and releases the resource when use by the mobile body is finished. With this configuration and operation, it is possible to efficiently arbitrate passage of the mobile body that moves autonomously.

### TECHNICAL FIELD

The present invention relates to a mobile body passage management system and a mobile body passage management method.

### BACKGROUND ART

Conventionally, a mobile body that autonomously travels is used in a factory, a distribution warehouse, and the like. As an example, there is an automatic guided vehicle that travels on a prescribed travel route and transports parts and performs cargo handling work. PTL 1 discloses control of a mobile body that autonomously travels. PTL 1 describes that a “mobile body system including: a flat plate sign arranged according to a preset travel route; and a mobile body that autonomously travels along the travel route, in which the mobile body system includes a distance direction detection apparatus that is provided in the mobile body and detects a distance and a direction between the mobile body and an object present in a search range by scanning a predetermined search range with detection light, and a traveling direction determination means for determining a traveling direction of the mobile body based on a detection result of the distance direction detection apparatus, and the flat plate sign includes a mirror surface and a diffuse reflection surface having a rate of diffuse reflection of incident light higher than that of the mirror surface”.

### CITATION LIST

### Patent Literature

PTL 1: Japanese Patent Application Publication No. 2012-113765

### SUMMARY OF INVENTION

### Technical Problem

As in the above-described conventional technique, travel control of a mobile body assuming an unmanned factory or the like is already used. Under such a limited environment, operations of a large number of mobile bodies can be collectively and integrally managed.

However, in recent years, against the background of a decrease in working population and the like, operation of a mobile body with higher versatility is required. For example, the operation is such that a transport robot, a cleaning robot, a security robot, and the like are operated in a building of a commercial facility where people are present.

In such an environment where there are various mobile bodies, arbitration of passage becomes a problem. This is because various problems occur when a plurality of robots try to pass freely at unique timings. As an example, for example, there is a case where a plurality of robots wait for an elevator and cannot move with each other. In addition, while a certain robot is traveling in a narrow corridor, another robot may come from the other side and recognize each other as an obstacle and cannot move.

In order to solve this problem, conventionally, a method of unifying operation management servers is adopted. However, it is necessary to modify each robot to match the specifications of the server, and the temporal and financial cost increases. In addition, it is out of the coverage of the robot vendor, and it may be difficult to refurbish the robot side.

Therefore, an object of the present invention is to efficiently arbitrate passage of a mobile body that moves autonomously.

### Solution to Problem

In order to achieve the above object, one of representative mobile body passage management systems of the present invention is a mobile body passage management system that manages passage of a mobile body that moves autonomously, in which the system includes a storage unit that stores a resource necessary for the passage of the mobile body as resource data, a resource management unit that manages an allocation situation of the resource to the mobile body, and a use request processing unit that receives a request from the mobile body, performs new allocation of the resource, and releases the resource when use by the mobile body is finished.

Further, one of representative mobile body passage management methods of the present invention is a mobile body passage management method for managing passage of a mobile body that moves autonomously, in which the method includes a step of receiving, by a resource management server that manages a resource necessary for the passage of the mobile body as resource data, a request for the resource from the mobile body, a step of permitting, by the resource management server, use of the requested resource in a case where the requested resource is usable as a result of referring to a use situation by another mobile body, and a step of, by the resource management server, rejecting use of the requested resource in a case where the requested resource is not usable as a result of referring to a use situation by another mobile body.

According to the present invention, it is possible to efficiently arbitrate the passage of the mobile body that moves autonomously. Problems, configurations, and effects other than those described above will be clarified by the following description of embodiments.

### BRIEF DESCRIPTION OF DRAWINGS

FIG. 1 is an explanatory diagram of arbitration of passage by a mobile body passage management system.

FIG. 2 is a system configuration diagram of the mobile body passage management system.

FIG. 3 is an explanatory diagram of components of the mobile body passage management system.

FIG. 4 is a configuration diagram of a building resource management server.

FIG. 5 is a flowchart for explaining allocation processing of a resource.

FIG. 6 is a configuration diagram of a robot.

FIG. 7 is a flowchart for explaining the operation of the robot.

FIG. 8 is a flowchart illustrating details of travel control.

### DESCRIPTION OF EMBODIMENTS

Hereinafter, embodiments will be described with reference to the drawings.

### Embodiment 1

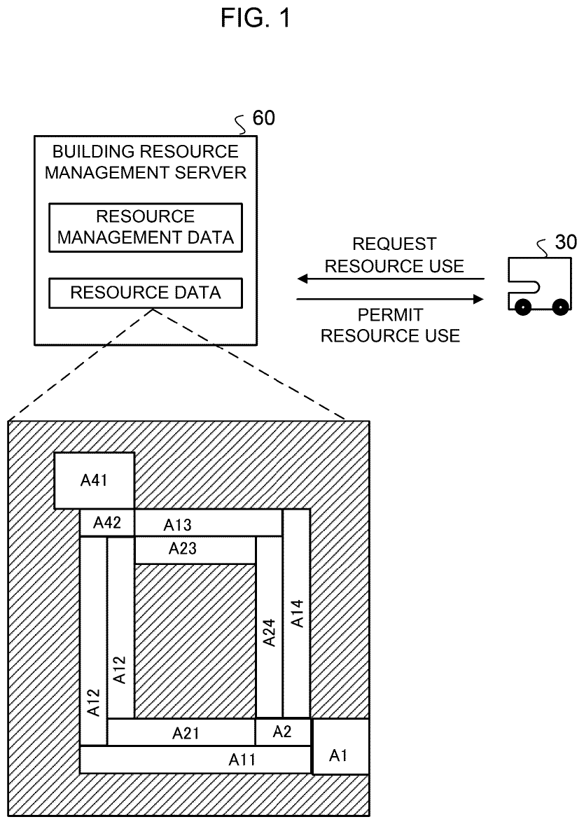

FIG. 1 is an explanatory diagram of arbitration of passage by a mobile body passage management system. The mobile body passage management system of the present embodiment manages passage of one or a plurality of robots 30. The robot 30 is a mobile body that moves autonomously, and is a transport robot, a cleaning robot, a security robot, or the like. The robot 30 moves inside the building and performs a given task.

In addition, the mobile body passage management system includes a building resource management server 60 that manages a resource of a building. The building resource management server 60 stores a resource necessary for passage of the robot 30 as resource data, and manages an allocation situation of the resource to the robot 30 by resource management data.

The resource data illustrated in FIG. 1 is data obtained by assigning identification data (ID) to sub areas obtained by dividing an area through which the robot 30 passes on a certain floor of a building. A sub area A1 having an ID “A1” is set at a doorway of the floor. Further, the sub areas A11 to A14 and the sub areas 21 to 24 are a part of a corridor in the floor. Sub areas A11 to A14 are on an outer peripheral side of the corridor, and sub areas A21 to A24 are on an inner peripheral side of the corridor. The sub area A2 couples the corridor and a doorway. The sub area A41 is an elevator, and the sub area 42 is an elevator hall.

The building resource management server 60 may provide the resource data to the robot 30. The robot 30 searches for a moving route of the robot using the resource data as map data. Then, the robot 30 transmits a resource use request to the building resource management server 60 for the sub area constituting the moving route.

The building resource management server 60 receives the request from the robot 30, performs new allocation of the resource, and releases the resource when the use by the mobile body is finished.

Here, the robot 30 determines a sub area to be requested to be allocated based on specifications and contents of the task of the robot. For example, when the size of the robot 30 is sufficiently small, an allocation can be requested for either the sub area A11 or the sub area A21, and the robot can travel in the corridor. However, when the size of the robot 30 is large, it is necessary to simultaneously request both the sub area A11 and the sub area A21. In addition, in order to execute a task of cleaning a corridor even when the size is small, both the sub area A11 and the sub area A21 may be requested at the same time.

As described above, the building resource management server 60 manages the resources of the building, so that the traffic of the passage of the plurality of robots 30 operating independently can be controlled and arbitrated autonomously.

For example, in a case where only one use permission is given to a certain sub area ID at a time, arbitration is achieved by an exclusive lock mechanism.

In addition, when the number available for a certain sub area ID is limited to a certain number, arbitration is achieved by the mechanism of the counting semaphore.

In addition, when permission to use a certain sub area ID is given only in a specific entry direction, arbitration is achieved by a mechanism of a passage light.

Note that, when the resource is allocated, it is also possible to notify the use condition together. As a condition of use, a request to the robot can be added by including a maximum speed limit, a maximum volume, a maximum luminous intensity, and the like.

The robot 30 may enter only when use registration is performed for the sub area ID to be moved. When a manager of the building flexibly sets “traffic rules” of the building, the operation can be performed according to the setting. For example, prohibition of traveling at night, requesting silencing, requiring a low light amount, traveling on one-way, or the like can be set.

In addition, in the configuration in which the building resource management server 60 manages resources of the building, it is possible to minimize refurbishment to be performed on the plurality of robots 30.

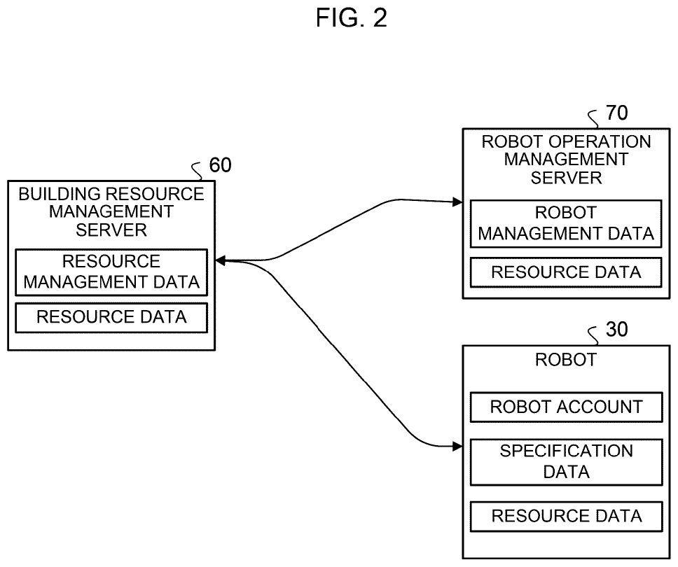

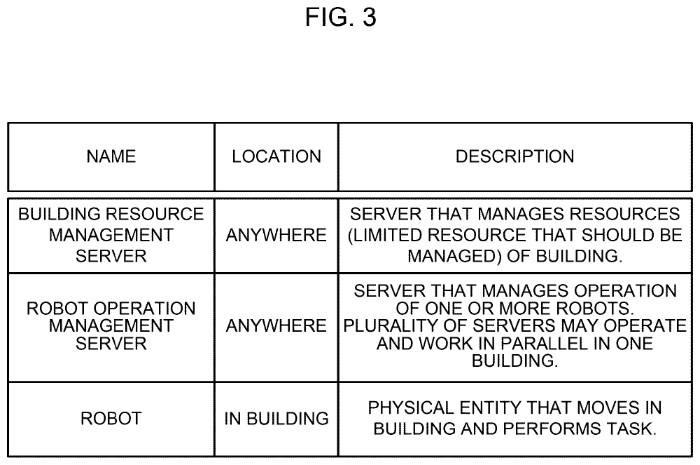

FIG. 2 is a system configuration diagram of the mobile body passage management system, and FIG. 3 is an explanatory diagram of components of the mobile body passage management system.

As illustrated in FIG. 2, the robot 30, the building resource management server 60, and a robot operation management server 70 are included.

The building resource management server 60 may be installed anywhere. The building resource management server 60 is a server that manages the resources (limited resources that should be managed) of the building. The resource may include sub areas obtained by dividing the area through which the robot 30 passes. In addition, an elevator can be used as a resource.

The robot operation management server 70 may be installed anywhere. The robot operation management server 70 is a server that manages the operation of one or more robots 30. A plurality of robot operation management servers 70 may operate in parallel in one building.

The robot 30 is located in a building. The robot 30 is a physical entity that moves in a building and performs a task.

The building resource management server 60 stores resource management data and resource data. The robot operation management server 70 stores robot management data and resource data. The resource data stored in the robot operation management server 70 is provided from the building resource management server 60. The robot management data is data that associates resource data with the situation of each robot 30.

The robot 30 stores a robot account, specification data, and resource data. The resource data stored in the robot 30 is provided from the building resource management server 60. The robot account is identification information that uniquely specifies the robot 30. The building resource management server 60 and the robot operation management server 70 identify the robot 30 by the robot account. The specification data indicates the specification of the robot 30. For example, a dimension, a weight, a turning radius, and the like of the robot 30 can be included in the specification data.

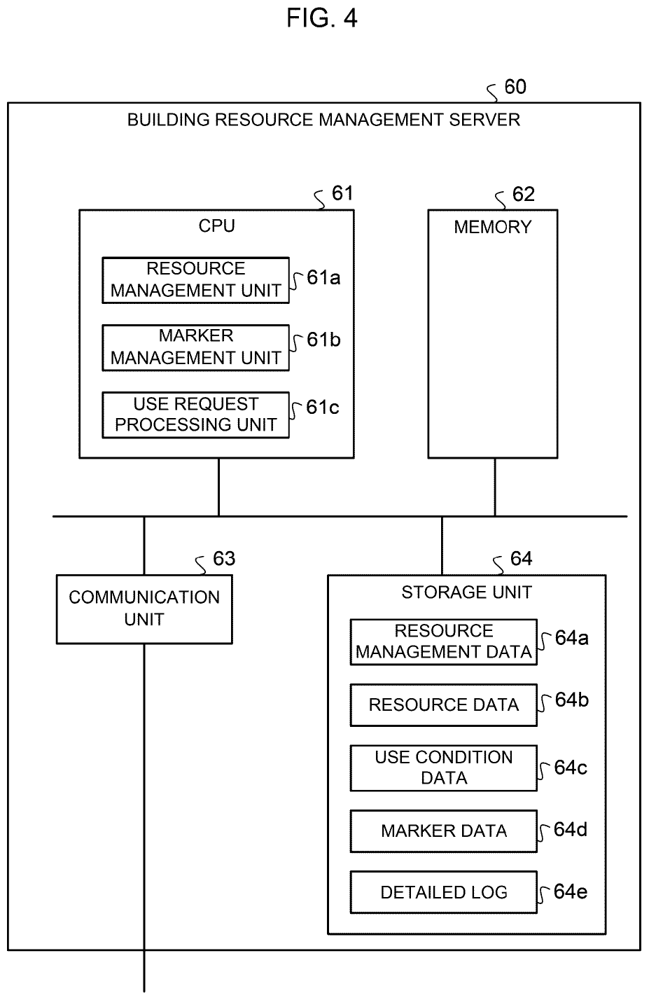

FIG. 4 is a configuration diagram of the building resource management server 60. As illustrated in FIG. 4, the building resource management server 60 includes a central processing unit (CPU) 61, a memory 62, a communication unit 63, and a storage unit 64.

The storage unit 64 is an auxiliary storage apparatus that stores programs and various data. The storage unit 64 stores resource management data 64a, resource data 64b, use condition data 64c, marker data 64d, and a detailed log 64e.

The resource management data 64a is data indicating an allocation situation of resources to the robot 30.

The resource data 64b indicates a resource necessary for passage of the mobile body. Specifically, the resource data is data in which an ID is assigned to a sub area obtained by dividing an area through which the robot 30 passes in a building. The resource data 64 can also be used as map data of the floor.

The use condition data 64c indicates a use condition of the resource. For example, the maximum speed limit, the maximum volume, the maximum luminous intensity, and the like can be set as the use conditions. The use condition data 64c is a so-called a “traffic rule” and can be flexibly determined. For example, prohibition of traveling at night, requesting silencing, requiring a low light amount, traveling on one-way, or the like can be set.

The marker data 64d is data in which position information of a marker arranged in an area through which the robot 30 passes is associated with identification data of the marker.

The detailed log 64e indicates an operation history of the own apparatus. By referring to this detailed log, how the building resource management server 60 operates can be analyzed later.

The communication unit 63 is a communication interface used when communicating with the robot 30 and the robot operation management server 70.

The CPU61 implements the functions of the resource management unit 61a, the marker management unit 61b, and the use request processing unit 61c by developing the program read from the storage unit 64 in the memory 62 which is a main storage apparatus and sequentially executing the program.

The resource management unit 61a manages the resource management data 64a and the resource data 64b. The resource management unit 61a can provide the resource data to the robot 30 and the robot operation management server 70. In addition, the resource management unit 61a updates the resource management data 64a when the resource allocation situation for the robot 30 changes.

The marker management unit 61b manages the marker data 64d. Upon receiving an inquiry specifying the identification information of the marker data from the robot 30, the marker management unit 61b provides the position information of the corresponding marker.

The use request processing unit 61c receives a request from the robot 30, performs new allocation of the resource, and releases the resource when the use by the robot 30 is finished. In addition, in a case where the resource is allocated to the mobile body, the use request processing unit 61c reads the use condition of the resource from the use condition data 64c and notifies the use condition.

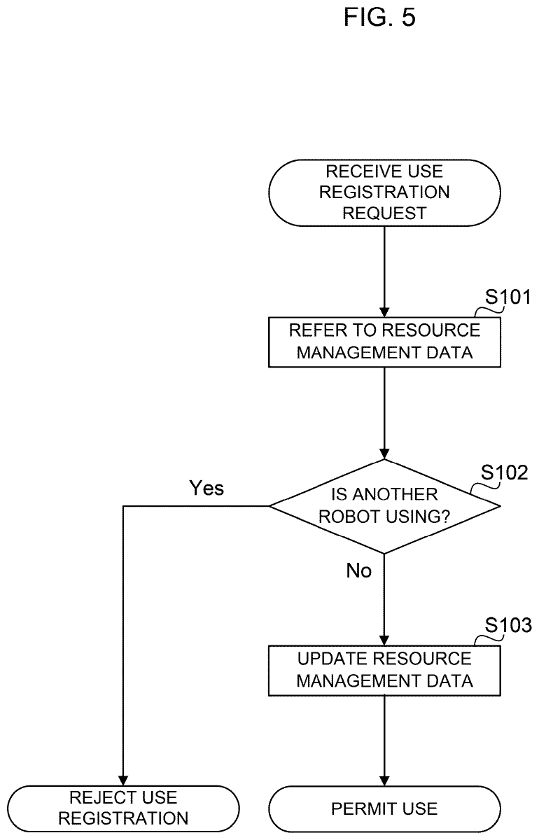

FIG. 5 is a flowchart for explaining allocation processing of the resource. Upon receiving a use registration request of the resource from the robot 30, the use request processing unit 61c refers to the resource management data 64a (Step S101). As a result of the reference, when another robot is using the requested resource (Step S102; Yes), the use request processing unit 61c transmits use registration rejection to the robot 30 which is the request source, and ends the processing.

Meanwhile, as a result of the reference, when the other robot is not using the requested resource (Step S102; No), the resource management unit 61a updates the resource management data 64a (Step S103), the use request processing unit 61c transmits the use permission to the robot 30 which is the request source, and ends the processing.

FIG. 5 illustrates an exclusive lock-type processing operation. In the case of the counting semaphore type, the availability may be determined by determining “how many other robots use the resource” and “when +1 is set, whether the value exceeds the set upper limit”. In addition, in the case of the passage light type, when a moving direction reported at the time of use registration matches a direction in which the permission is given now, the use permission may be given.

In addition, as described above, in a case where the use condition is set for the resource, when the use request processing unit 61c transmits the use permission to the robot 30 which is the request source, a message indicating the use condition is transmitted together.

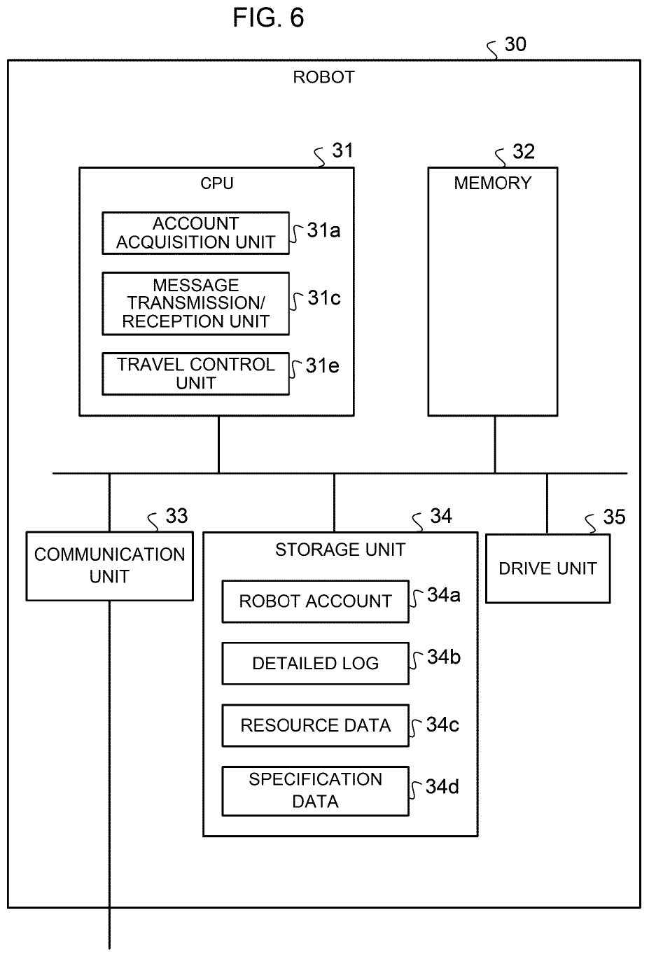

FIG. 6 is a configuration diagram of the robot 30. As illustrated in FIG. 6, the robot 30 includes a CPU31, a memory 32, a communication unit 33, a storage unit 34, and a drive unit 35.

The drive unit 35 is a unit that drives the robot 30, and includes wheels, a motor, and the like.

The storage unit 34 is an auxiliary storage auxiliary storage apparatus that stores programs and various data. The storage unit 34 stores a robot account 34a, a detailed log 34b, resource data 34c, and specification data 34d.

The robot account 34a is identification information that uniquely specifies the robot 30.

The detailed log 34b indicates an operation history of the own apparatus. By referring to this detailed log, how the robot 30 operates can be analyzed later.

The resource data 34c is data received from the building resource management server 60.

The specification data 34d indicates a specification of the robot 30. For example, a dimension, a weight, a turning radius, and the like of the robot 30 can be included in the specification data.

The communication unit 33 is a communication interface used when communicating with the building resource management server 60 and the robot operation management server 70 mediation server 10.

The CPU31 implements the functions of an account acquisition unit 31a, a message transmission/reception unit 31c, and a travel control unit 31e by developing the program read from the storage unit 34 in the memory 32 which is a main storage apparatus and sequentially executing the program.

The account acquisition unit 31a performs processing of acquiring a new account. Specifically, the account acquisition unit 31a receives issuance of a robot account from a predetermined server, and stores the issued robot account 34a in the storage unit 34. The account may be acquired as an initial setting when the robot 30 is introduced into the system.

The message transmission/reception unit 31c is a processing unit that transmits and receives a message to and from building resource management server 60. The messages to be transmitted and received are “reception of resource data”, “transmission of marker identification data”, “reception of marker data”, “transmission of a resource use registration request”, “reception of use permission”, “transmission of a resource release request”, and the like.

The travel control unit 31e controls the drive unit 35 based on the transmitted and received message to cause the robot 30 to travel.

In addition, the robot 30 includes various sensors, a mechanism for executing a task, and a processing unit, but the description thereof is omitted here.

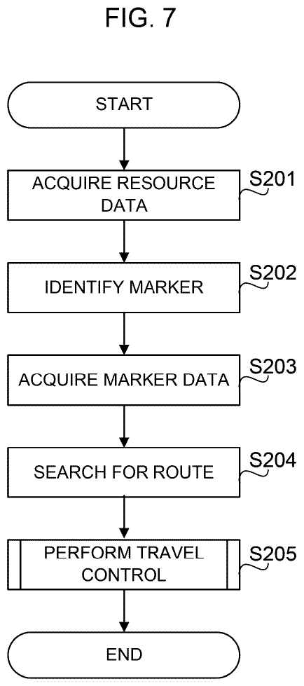

FIG. 7 is a flowchart for explaining the operation of the robot 30. First, the message transmission/reception unit 31c acquires resource data from the building resource management server 60 and stores the resource data in the storage unit 34 (Step S201).

Thereafter, the message transmission/reception unit 31c identifies a marker around the own apparatus (Step S202). The message transmission/reception unit 31c transmits the identification data of the marker obtained by the identification to the building resource management server 60, and acquires the marker data indicating the position of the marker (Step S203). The position of the marker is, for example, a relative position with respect to the resource data, and the message transmission/reception unit 31c that has acquired the marker data can specify the positional relationship of the own apparatus with respect to the resource data.

The travel control unit 31e searches for a route using the positional relationship of the resource data and the own apparatus (Step S204). Thereafter, the travel control unit 31e and the message transmission/reception unit 31c perform travel control along the determined moving route (Step S205).

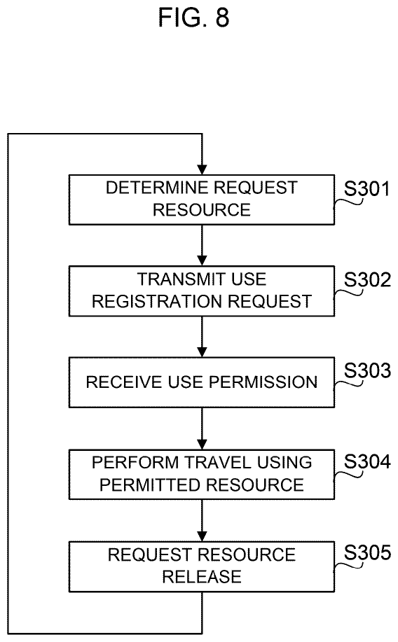

FIG. 8 is a flowchart illustrating details of the travel control. First, the message transmission/reception unit 31c determines a resource to be requested based on the moving route, the source data 34c, and the specification data 34d (Step S301). The message transmission/reception unit 31c transmits a use registration request for the determined resource to building resource management server 60 (Step S302).

Thereafter, when the use permission is received from the building resource management server 60 (Step S303), the travel control unit 31e performs travel using the permitted resource (Step S304). The message transmission/reception unit 31c requests the building resource management server 60 to release the resource that has been used (step 305), and repeats the processing from Step S301.

As described above, the disclosed mobile body passage management system is a mobile body passage management system that manages passage of a mobile body that moves autonomously, and the system includes the storage unit 64 that stores a resource necessary for passage of the robot 30 which is the mobile body as resource data, the resource management unit 61a that manages the allocation situation of the resource to the mobile body, and a use request processing unit 61c that receives a request from the mobile body, performs new allocation of the resource, and releases the resource when use by the mobile body is finished.

With this configuration and operation, the mobile body passage management system can efficiently arbitrate the passage of the mobile body that moves autonomously.

Further, the resource data is data obtained by assigning identification data to sub areas obtained by dividing an area through which the mobile body passes in a building, and the mobile body designates a sub area to be used by the mobile body and receives an allocation.

Further, the resource management unit 31a provides the resource data to the mobile body, and the mobile body searches for a moving route using the resource data and requests allocation of sub areas constituting the moving route.

With this configuration and operation, the mobile body can use the resource data for both the route search and the resource request, and the operation can be made efficient.

In addition, the mobile body stores specification data indicating the specification of the mobile body, and determines a sub area for which allocation is requested based on the specification data.

Therefore, the resource to be acquired can be flexibly determined according to the mobile body.

In addition, the use request processing unit 61c notifies the mobile body of a use condition of the resource when allocating the resource to the mobile body.

Therefore, it is possible to determine a rule regarding passage of the mobile body in detail and flexibly change the rule.

The storage unit 64 further stores marker data in which position information of a marker disposed in an area through which the mobile body passes is associated with identification data of the marker, and the mobile body passage management system further includes the marker management unit 61b that provides position information of a corresponding marker when an inquiry specifying identification information of the marker data is received from the mobile body.

According to this configuration and operation, the mobile body can specify the position of the own apparatus based on the marker that can be recognized from the current location.

Note that the present invention is not limited to the above embodiment, and includes various modifications. For example, the above-described embodiments have been described in detail for easy understanding of the present invention, and are not necessarily limited to those having all the described configurations. In addition, the configuration is not limited to the deletion, and the configuration can be replaced or added.

For example, in the above embodiment, the robot that performs work in a building has been exemplified, but the present invention is also applicable to a mobile body that moves outdoors. In addition, the mode of movement is not limited to traveling, and may be flight, navigation, or the like.

### REFERENCE SIGNS LIST

30 Robot
31 CPU
31a Account acquisition unit
31c Message transmission/reception unit
31e Travel control unit
32 Memory
33 Communication unit
34 Storage unit
34a Robot account
34b Detailed log
34c Resource data
34d Resource data
35 Drive unit
60 Building resource management server
61 CPU
62 Memory
63 Communication unit
64 Storage unit
64a Resource management data
64b Resource data
64c Use condition data
64e Detailed log
70 Robot operation management server

1. A mobile body passage management system that manages passage of a mobile body that moves autonomously,
wherein a resource management server is provided separately from an operation management server that manages the mobile body,
the resource management server includes
a storage unit that stores a resource necessary for the passage of the mobile body as resource data,
a resource management unit that manages an allocation situation of the resource to the mobile body, and
a use request processing unit that receives a request from the mobile body, performs new allocation of the resource, and releases the resource when use by the mobile body is finished, and
the operation management server manages an operation of the mobile body by associating the resource data provided from the resource management server with a situation of the mobile body.

2. The mobile body passage management system according to claim 1,
wherein the resource data is data obtained by assigning identification data to sub areas obtained by dividing an area through which the mobile body passes in a building,
the sub areas are allocable in different combinations according to specifications and/or tasks of the mobile body, and
the mobile body designates a sub area to be used by the mobile body and receives an allocation.

3. The mobile body passage management system according to claim 1,
wherein the resource data is data obtained by assigning identification data to sub areas obtained by dividing an area through which the mobile body passes in a building,
the mobile body designates a sub area to be used by the mobile body and requests allocation, and
the use request processing unit controls traffic of passage of a plurality of independently operating mobile bodies by performing any one of
control to give use permission to only one of the mobile bodies at a time with respect to the sub area,
control to limit the number available for the sub area to a predetermined number, and
control to give use permission to the sub area only in a specific entry direction.

4. The mobile body passage management system according to claim 2,
wherein the resource management unit provides the resource data to the mobile body, and
the mobile body searches for a moving route using the resource data, and requests allocation of sub areas constituting the moving route.

5. The mobile body passage management system according to claim 2,
wherein the mobile body stores specification data indicating the specification of the mobile body, and determines a sub area for which allocation is requested based on the specification data.

6. The mobile body passage management system according to claim 1,
wherein the use request processing unit notifies the mobile body of a use condition of the resource when allocating the resource to the mobile body, and
the use condition includes at least one of a maximum speed limit, a maximum volume, a maximum luminous intensity, and a limit changed by time.

7. The mobile body passage management system according to claim 1, wherein
the storage unit further stores marker data in which position information of a marker disposed in an area through which the mobile body passes is associated with identification data of the marker, and
the mobile body passage management system further includes a marker management unit that provides position information of a corresponding marker when an inquiry specifying identification information of the marker data is received from the mobile body.

8. The mobile body passage management system according to claim 1,
wherein a plurality of mobile bodies moves autonomously to perform a task,
the resource management server is provided separately from a plurality of operation management servers that manage movement of the mobile body,
the plurality of operation management servers manage the movement of the mobile body by associating the resource data provided from the resource management server with a situation of the movement of the mobile body managed by each of the plurality of operation management servers,
the resource data is data representing a plurality of sub areas obtained by dividing an area through which the mobile body passes in a building,
each of the plurality of sub areas has an area, and is allocable in different combinations of sub areas according to a size and the task of the mobile body, and
the mobile body searches for a moving route of the mobile body, determines a sub area for which allocation is requested based on the size and task of the mobile body and the moving route, specifies one of the sub areas and requests allocation from the resource management server when one sub area to be used by the mobile body is sufficient, specifies a combination of a plurality of sub areas at the same time and requests allocation from the resource management server when the combination of the plurality of sub areas adjacent to each other in a direction in which the mobile body moves is required based on the size of the mobile body, specifies the combination of the plurality of sub areas at the same time and requests allocation from the resource management server in a case where the combination of the sub areas is required based on the task of the mobile body even when the combination of the sub areas is not required based on the size of the mobile body, and receives allocation of the sub area or the combination of the sub areas from the resource management server.

9. A mobile body passage management method for managing passage of a mobile body that moves autonomously, the mobile body passage management method comprising:
a step of receiving, by a resource management server that is provided separately from an operation management server that manages the mobile body and stores and manages a resource necessary for the passage of the mobile body as resource data, a request for the resource from the mobile body;
a step of permitting, by the resource management server, use of the requested resource in a case where the requested resource is usable as a result of referring to a use situation by another mobile body; and
a step of, by the resource management server, rejecting use of the requested resource in a case where the requested resource is not usable as a result of referring to a use situation by another mobile body,
wherein the operation management server manages the operation of the mobile body by associating the resource data provided from the resource management server with a situation of the mobile body.
